(19) United States
(12) Patent Application Publication
(10) Pub. No.: US 2013/0124778 A1
(43) Pub. Date: May 16, 2013

(54) METHOD OF STORING HOST DATA AND META DATA IN A NAND MEMORY, A MEMORY CONTROLLER AND A MEMORY SYSTEM

(71) Applicants: Siamak Arya, Cupertino, CA (US); Dongsheng Xing, Fremont, CA (US)

(72) Inventors: Siamak Arya, Cupertino, CA (US); Dongsheng Xing, Fremont, CA (US)

(73) Assignee: Greenliant LLC

(21) Appl. No.: 13/293,904

(22) Filed: Nov. 10, 2011

(51) Int. Cl. G06F 12/00

(52) U.S. Cl. 711/103; 711/E12.008

(57) ABSTRACT

A host device connected to memory devices, with each memory device having NAND memory chips and an associated controller. Each NAND memory chip can store a page of data in a single write operation, and can read a page of data from NAND memory in a single read operation, with the page being the smallest unit of storage and having a plurality of bits. The controller of each memory chip partitions each page of the associated NAND memory chip into first, second and third locations. The first location is for storage of host data. The second location is for storage of controller meta data. The third location is for storage of meta data of the host device associated with the host data. The host data, meta data of the controller, and meta data of the host device are written into or read from a page in a single operation.

### TECHNICAL FIELD

The present invention relates to a method for storing host data and meta data in the same page of a non-volatile memory, in which the page of data is the minimum amount of data that can be read from or written to the non-volatile memory in a single operation. The present invention also relates to a memory controller that executes the foregoing described method as well as a memory system with a memory controller that executes the method.

### BACKGROUND OF THE INVENTION

Non-volatile memory chips that store or read a unit of data at a time, such as a page of data, are well known in the art. For example, NAND memory chips typically can store a page, such as 4 kilobytes, of data in the chip at each write operation. (Typically, a plurality of such pages are erased together in a unit called a block). Other types of non-volatile memory devices that store or read a page of data at a time, include so called managed NAND memory devices, such as the NANDrive memory device available from Greenliant Systems, Inc. of Santa Clara Calif..

In a NAND memory chip, the memory can be written to or read from only in units of data at a time, called pages. Because of their ability to read back a page of data at a time, NAND memory chips are useful to store large amounts of data.

In the prior art, because NAND memory chips are subject to error, the memory controller associated with the NAND memory chip generates error checking data, such as ECC bits. Error checking bits are of course dependent upon the underlying data (“host data”). In addition, the memory controller may also generate data referencing or correlating the location of the page of data in the NAND memory chip where the host data is stored or to be stored with the logical address. All of these types of data, such as ECC data, or data correlating physical address to logical address are referred to as meta data. The meta data is generated by the memory controller, based upon the host data or the location of the host data.

In the prior art, the manufacturers of the NAND memory chip have designed their memory chips such that a page also has spare bytes associated with that page. The number of spare bytes associated with each page of bits has varied from manufacturer to manufacturer. These spare bytes, however, are not user accessible to store host data and may be used only by the associated memory controller to store data such as error correction data associated with the host data stored in the associated page.

Referring to FIG. 1 there is shown a schematic block diagram of a memory system 10 of the prior art. A host device 12, such as a computer, is in communication with a plurality of memory controllers 20(a-f). Each memory controller 20 has an associated NAND memory chip 30. Collectively, the memory controller 20 and the associated NAND memory 30 may be a NANDrive available from Greenliant Systems Inc of Santa Clara, Calif..

The meta data generated by the memory controller 20 during the write operation is stored in the NAND memory 30 and is also needed by the memory controller 20 during the read operation. For example, the error checking bits are used by the memory controller 20 after a read operation of the host data from the NAND memory chip 30 to confirm that there are no errors in the host data read.

In the memory system 10 of the prior art, in addition to the meta data generated by the memory controller 20, meta data is also generated by the host device 12. Among the type of meta data generated by the host device 12 include the logical address and CRC of the host data etc. In the prior art, the meta data generated by the host device 12 was either stored in volatile memory (not shown), which was backed up into a non-volatile memory since a loss in power would cause the loss of such meta data, or in an external non-volatile memory 16. Typically, in the prior art, the user space is divided into space to store host data and space to store meta data. There are many ways to allocate these spaces, and all of them may cause a reduction in the space to store host data. Some approaches may cause performance degradation if two different read operations would be required to retrieve host data and its corresponding meta data separately. Or, if meta data is cached to avoid the performance degradation, a large RAM will be required, which will cause an undesirable increase in the cost of the system.

### SUMMARY OF THE INVENTION

Accordingly, in the present invention, a method of operating a memory system having a host device connected to a plurality of memory devices, with each memory device having a NAND memory chip, and an associated controller is disclosed. The NAND memory chip can store a page of data in a single write operation and can read a page of data from the NAND memory in a single read operation, with the page being the smallest unit of storage and having a plurality of bits. The controller partitions each page of an associated NAND memory into a first location, a second location, and a third location. The first location is for the storage of host data. The second location is for the storage of meta data of the controller associated with the host data. The third location is for the storage of meta data of the host device associated with the host data. The host data, meta data of the controller, and meta data of the host device are written into the same page in a single write operation.

The present invention also relates to a method of reading a page of a NAND memory chip, with the page having a plurality of bits. After a page is read, the memory controller extracts from the plurality of bits a first plurality of bits of host data, a second plurality of bits of meta data for the controller associated with the NAND memory read, and a third plurality of bits of meta data for the host device.

The present invention also relates to a memory controller for controlling a non-volatile memory chip. The memory controller has a processor and a non-volatile memory for storing programming code for execution by the processor in accordance with the foregoing described method.

Finally, the present invention relates to a memory system having a host device connected to a plurality of independent memory devices, with each memory device comprising the foregoing described memory controller for controlling an associated NAND memory chip.

### BRIEF DESCRIPTION OF THE DRAWINGS

FIG. 1 is a block level diagram of a memory system operated in accordance with the method of the prior art.

FIG. 2 is a schematic block diagram of a memory system for operating the method of the present invention.

### DETAILED DESCRIPTION OF THE INVENTION

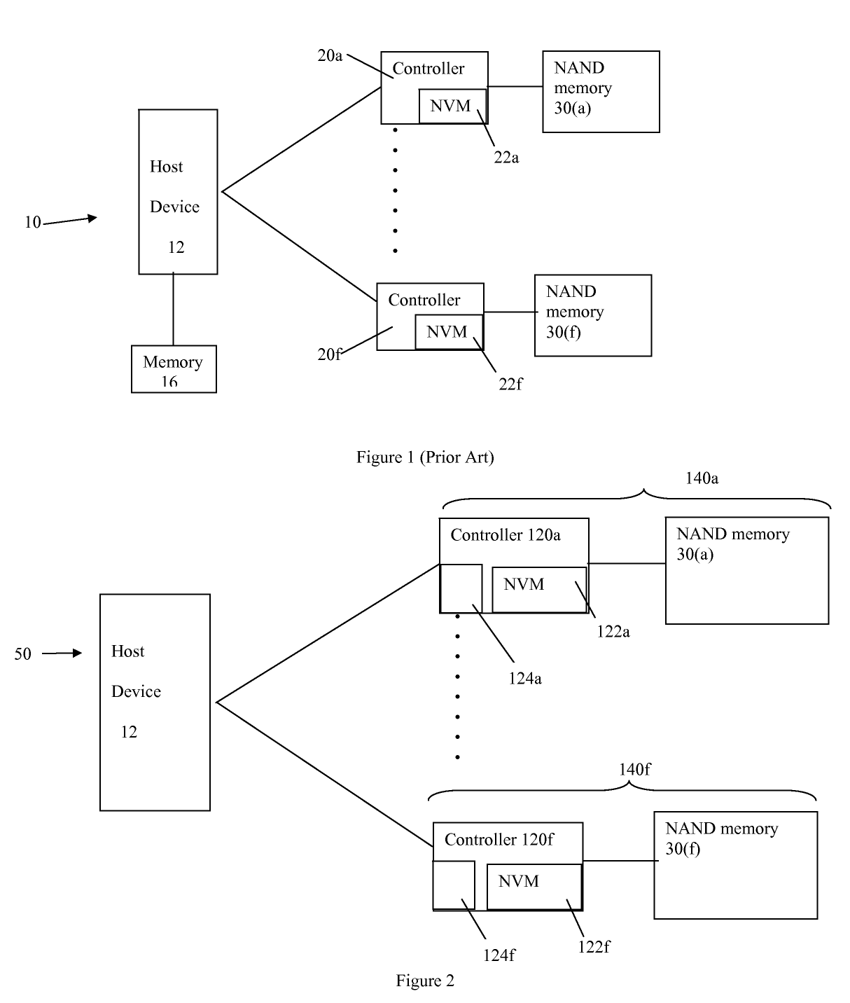

Referring to FIG. 2 there is shown a memory system 50 of the present invention. The memory system 50 of the present invention is similar to the memory system 10 shown in FIG. 1. Thus, like numerals will be used for like parts. The system 50 comprises a host device 12, such as a computer. The host device 12 is in communication with a plurality of memory controllers 120(a-f). Each memory controller 120 has a processor 124 and a non-volatile memory 122 usually embedded with the processor 124. The non-volatile memory 122 stores programming code for execution by the processor 124, which will be explained in greater detail hereinafter. Each memory controller 120 has an associated NAND memory chip 30. The memory controller 120 has a standard interface, such as SATA (serial ATA) to interface with the host device 12.

The programming code stored in the non-volatile memory 122 causes the processor 124 to control the read/write of host data from/into the associated NAND memory chip 30, in accordance with the method of the present invention, as discussed hereinafter. In addition, the programming code causes the processor 124 to generate error checking codes, based upon the host data, as well as data correlating the location of the physical address in the associated NAND memory chip 30 where the data is read from or written to with the logical address (collectively “meta data”). Other meta data may also be generated by the memory controller 120. The programming code can be stored in the non-volatile memory 122, which is embedded with the processor 124 in the memory controller 120. Alternatively, the programming code can be stored in a non-volatile memory which is discrete and separate from the memory controller 120, such as within the NAND memory chip 30.

As discussed hereinabove, meta data is also generated by the host device 12 during the read or write operation. The host meta data is also supplied to the selected one of the plurality of memory controllers 120. The programming code stored in the non-volatile memory 122 also causes the processor 124 of the memory controller 120 to operate on the meta data from the host device 12. The method of reading and writing of the present invention is explained as follows:

### WRITE

In a write operation host data to be stored in the memory system 50 is first supplied to the host device 12. The host device 12 may choose a particular storage device 140 e.g. storage device 140(a), depending on a number of factors, such as the availability of space in that storage device 140(a), data distribution strategy, as well as other types of information. The host device 12 will also generate some information about the data, usually, in order to detect errors or recover from some types of failures. The data representing information about the data is collectively referred to as “host meta data”. The host meta data along with the host data is then supplied to the memory controller 120(a) associated with the selected storage device 140(a).

After the selected memory controller 140(a) receives the host meta data and the host data, the memory controller 120(a) will store the host meta data along with controller meta data that is generated by the controller 120 in the spare bytes of the page of the NAND memory 30 where the host data is stored. Typically, the host data stored in NAND page is protected against errors by some encoding mechanism. Thus, the host meta data, as well as the controller meta data, may also be protected by such error correction mechanisms.

In order to be able to store the host data, the associated controller meta data and the associated host meta data in the same page (including the associated spare bytes) of the NAND memory 30, it may require the host device 12 to adjust the amount of host meta data to the space available in the NAND page spare bytes, so that the entirety of the host data, and its associated controller meta data, and the associated host meta data may all fit in the same NAND page. At initial blush, this may be disadvantageous in that the amount of space for host meta data may be less than the space available to store all the host meta data. In that event, the host device 12 must decide which host meta data to store and which host meta data to discard, balancing performance with redundancy or error correction. In some cases, it may require the host meta data to be stored in the space which would otherwise be intended for the host data, thereby reducing the space for storage of host data. However, the benefit of having the host data, associated controller meta data and associated host meta data all available in a single write operation to write into the same NAND page (and subsequent read from the same NAND page) outweighs any such potential disadvantage.

### READ

When the host device 12 receives a read command it looks up its address table and selects the appropriate storage device and its associated memory controller 120.

Once the appropriate memory controller 120(a) is selected, the host device 12 communicates the read request to the selected memory controller 120(a). The memory controller 120(a) then causes a read operation to occur to read the selected page of data from the NAND chip 30(a). The selected page of data from the NAND chip 30(a) is then separated to the host data, the controller meta data and the host meta data. The memory controller 120(a) then uses the controller meta data to verify the host data. The verified host data is then passed to the host device 12, along with the host meta data.

As can be seen from the foregoing, with the method and controller and system of the present invention, read and write operations can be accomplished in a single operation with both host data and meta data collectively read from or written into a page of the NAND chip 30. Thus, performance is increased.

1. A method of operating a memory system having a host device connected to a plurality of memory devices, which each memory device having a NAND memory, and an associated controller, with said NAND memory for storing a page of host data in a single write operation and for reading a page of host data from the NAND memory in a single read operation, wherein a page has a plurality of bits, wherein said method comprising:
partitioning by a controller each page of an associated NAND memory and spare bits associated with that page into a first location for the storage of host data, a second location for the storage of meta data of the controller associated with said host data, and a third location for the storage of meta data of the host device associated with said host data; and
storing in a single write operation host data in said first location, and meta data of the controller in said second location and meta data of the host device in said third location of the same page.

2. The method of claim 1 wherein said meta data of the controller and of the host device are protected by an error correction scheme.

3. A method of operating a memory system having a host device connected to a plurality of memory devices, which each memory device having a NAND memory, and an associated controller, with said NAND memory for storing a page of host data in a single write operation and for reading a page of host data from the NAND memory in a single read operation, wherein a page has a plurality of bits, wherein said method comprising:
reading a page of a NAND memory and its associated spare bits, said page comprising a plurality of bits; and
extracting from said plurality of bits a first plurality of bits of host data, a second plurality of bits of meta data for the controller associated with the NAND memory read, and a third plurality of bits of meta data for the host device.

4. The method of claim 3 wherein the third plurality of bits of meta data are encoded for error control.

5. A memory controller for controlling the storage of a plurality of units or pages of data in an associated non-volatile memory device, wherein each unit or page of data comprises a plurality of bits and is the minimum amount of data that can be written to or read from the non-volatile memory device, said memory controller comprising:
a processing unit for partitioning each page into a first location for the storage of host data, a second location for the storage of meta data of the memory controller associated with said host data, and a third location for the storage of meta data of a host device communicating with the memory controller with said meta data of the host device associated with said host data;
storing in a single write operation host data in said first location, and meta data of the memory controller, in said second location and meta data of the host device, in said third location, all in the same page; reading a page of data from the associated non-volatile memory device in a single read operation; and extracting from said page of data a first plurality of bits of host data, a second plurality of bits of meta data for the memory controller associated with the host data read, and a third plurality of bits of meta data for the host device.

6. A memory system comprising:
a plurality of non-volatile memory devices, wherein each non-volatile memory device being capable of being written to or read from in a page of data wherein said page of data is the minimum amount of data that can be written to or read from a non-volatile memory device;
a memory controller associated with each non-volatile memory device for controlling the operation of the associated non-volatile memory device;
a host device for communicating with each memory controller;
each memory controller comprises:
a processor; and
a memory for storing programming code for execution by said processor, said programming code for partitioning each page in the associated non-volatile memory device into a first location for the storage of host data, a second location for the storage of meta data of the memory controller associated with said host data, and a third location for the storage of meta data of the host device with said meta data of the host device associated with said host data;
storing host data in said first location, and meta data of the memory controller in said second location and meta data of the host device in said third location, all in the same page in a write operation; reading a page of data from the associated non-volatile memory device in a read operation; and extracting from said page of data a first plurality of bits of host data, a second plurality of bits of meta data for the memory controller, and a third plurality of bits of meta data for the host device.

7. A method of operating a memory system having a plurality of non-volatile memory devices, wherein each non-volatile memory device being capable of independently written to or read from in a page of data wherein said page of data is the minimum amount of data that can be written to or read from a non-volatile memory device; and a plurality of memory controllers, with each memory controller associated with a non-volatile memory device for controlling the storage of a plurality of page of data in each associated non-volatile memory device, a host device communicating with said plurality of memory controllers for storing host data in said plurality of non-volatile memory devices and for reading host data therefrom, said method comprises:
writing host data to said memory system by:
partitioning by a memory controller each page of an associated non-volatile memory device into a first location for the storage of the host data, a second location for the storage of meta data generated by the memory controller associated with said host data, and a third location for the storage of meta data generated by the host device associated with said host data;
storing host data in said first location, and meta data of the memory controller in said second location and meta data of the host device in said third location in the same page in a single write operation;
reading from said memory system at a desired address by:
reading a page of a non-volatile memory device, said page comprising a plurality of bits; and
extracting from said plurality of bits a first plurality of bits of host data, a second plurality of bits of meta data for the memory controller associated with the non-volatile memory device read, and a third plurality of bits of meta data for the host device; and
supplying said host data from the first plurality of bits and third plurality of bits of meta data for the host device to the host device.
